(19) United States
(12) Patent Application Publication
(10) Pub. No.: US 2023/0115962 A1
(43) Pub. Date: Apr. 13, 2023

(54) RADIO FREQUENCY CONNECTOR, ANTENNA ASSEMBLY, AND BASE STATION ANTENNA

(71) Applicant: CommScope Technologies LLC, Hickory, NC (US)

(72) Inventors: Yongjie Xu, Suzhou (CN); Liqing Wang, Suzhou (CN); Qiyun Gu, Suzhou (CN)

(21) Appl. No.: 17/822,288

(22) Filed: Aug. 25, 2022

(30) Foreign Application Priority Data
Sep. 26, 2021 (CN) 202111126705.4

(51) Int. Cl. H01Q 1/24; H01Q 5/335

(52) U.S. Cl. CPC H01Q 1/246; H01Q 5/335

(57) ABSTRACT

The present disclosure relates to an RF connector for base station antennas, which comprises an inner conductor, an outer conductor, and an insulator between the inner conductor and the outer conductor; wherein the inner conductor and the outer conductor of the RF connector are formed of conductive polymer, and the RF connector is manufactured through a co-extrusion molding process. In addition, the present disclosure also relates to an antenna assembly and a base station antenna.

### RELATED APPLICATION

The present application claims priority from and the benefit of Chinese Patent Application No. 202111126705.4, filed Sep. 26, 2021, the disclosure of which is hereby incorporated herein by reference in full.

### FIELD OF THE INVENTION

The present disclosure relates to the field of wireless communications in general. More specifically, the present disclosure relates to a radio frequency connector for base station antennas, an antenna assembly, and a base station antenna.

### BACKGROUND OF THE INVENTION

Cellular communications systems are well known in the art. In a cellular communications system, a geographic area is divided into a series of sections that are referred to as “cells” which are served by respective base stations. The base station may include one or more base station antennas that are configured to provide two-way radio frequency (“RF”) communications with mobile subscribers that are within the cell served by the base station.

The base station antenna may include a reflector, which may include a metal surface that serves as a ground plane and reflects electromagnetic radiation reaching the reflector, so that the electromagnetic radiation can be redirected to propagate, for example, forwardly. The base station antenna may include a feeder panel arranged at a front side of the reflector and a linear or planar phased array of a radiating element mounted on the feeder panel. In addition, the base station antenna may further include additional mechanical and electronic components, for example, one or a plurality of connectors, cables, calibration plates, phase shifters, remote electrical tilt units, or duplexers, arranged on a rear side of the reflector. The base station antenna may be mounted on an elevated structure, for example, an antenna tower, a telegraph pole, a building, or a water tower, for ease of operation, such that the reflector of the antenna extends substantially perpendicular to the ground.

Generally, in a base station antenna, two RF devices, such as two printed circuit boards, may be connected together through RF connectors installed on the ends of a coaxial cable. These RF connectors usually include rigid metal inner conductors (copper or aluminum conductors), insulators, and rigid metal outer conductors (copper or aluminum conductors). Therefore, these components need to be assembled together during manufacturing, which increases the manufacturing process and cost. In addition, in order to realize electrical connection, it is also typically necessary to additionally use soldering technology to solder the connector to the pad on the RF device.

### SUMMARY OF THE INVENTION

The present disclosure provides an RF connector, an antenna assembly and a base station antenna that are capable of overcoming or improving at least one of the above-mentioned defects in existing products.

A first aspect of the present disclosure relates to an RF connector for base station antennas, which comprises an inner conductor, an outer conductor, and an insulator between the inner conductor and the outer conductor, wherein the inner conductor and the outer conductor of the RF connector are formed of conductive polymer, and the RF connector is manufactured through a co-extrusion molding process.

In some embodiments, the RF connector is configured as a flexible RF connector.

In some embodiments, the inner conductor, the outer conductor, and the insulator of the RF connector are constructed in one piece by means of the co-extrusion molding process.

In some embodiments, the inner conductor of the RF connector includes an inner conductor body composed of an insulating polymer and conductive particles doped into the inner conductor body; the insulator of the RF connector is composed of the insulating polymer; and the outer conductor of the RF connector includes an outer conductor body composed of the insulating polymer and conductive particles doped into the outer conductor body.

In some embodiments, the insulating polymer is silicone rubber.

In some embodiments, the conductive particles are aluminum particles, silver particles, and/or copper particles.

In some embodiments, the RF connector is configured as a cylindrical connector.

In some embodiments, the inner conductor of the RF connector is configured as a conductive column in the central area of the RF connector.

In some embodiments, a first notch is provided at the end of the outer conductor of the RF connector so as to remove the corresponding conductive polymer, thereby exposing the insulator.

In some embodiments, the insulator of the RF connector is formed into a ring shape with at least one second notch in cross-section.

In some embodiments, the outer conductor of the RF connector is formed with at least one protruding bar on the outer surface.

In some embodiments, the outer conductor of the RF connector is configured with two opposite protruding bars on the outer surface.

In some embodiments, the RF connector is configured to electrically connect the first RF device and the second RF device in a base station antenna.

In some embodiments, the inner conductor of the RF connector is electrically connected to the transmission trace on the first RF device at the first end surface, and the outer conductor of the RF connector is electrically connected to the ground portion on the first RF device at the first end surface; and the inner conductor of the RF connector is electrically connected to the transmission trace on the second RF device at the second end surface, and the outer conductor of the RF connector is electrically connected to the ground portion on the second RF device at the second end surface.

In some embodiments, the inner conductor and the outer conductor of the RF connector are configured flush with each other on the first end surface and the second end surface.

A second aspect of the present disclosure relates to an antenna assembly comprising a first RF device, a second RF device, and an RF connector electrically connecting the first RF device and the second RF device, wherein the RF connector is configured as an RF connector according to one of embodiments.

In some embodiments, the antenna assembly further comprises a substrate between the first RF device and the second RF device, wherein an opening for the RF connector to span is provided in the substrate.

In some embodiments, the cross-sectional shape of the opening is circular or oval according to the cross-section of the RF connector.

In some embodiments, a first inner conductor contact portion and a first outer conductor contact portion are provided on the first RF device, wherein the first inner conductor contact portion and the inner conductor of the RF connector are electrically connected through planar contact with each other on the first end surface of the inner conductor, and the first outer conductor contact portion and the outer conductor of the RF connector are electrically connected through planar contact with each other on the first end surface of the outer conductor; and a second inner conductor contact portion and a second outer conductor contact portion are provided on the second RF device, wherein the second inner conductor contact portion and the inner conductor of the RF connector are electrically connected through planar contact with each other on the second end surface of the inner conductor, and the second outer conductor contact portion and the outer conductor of the RF connector are electrically connected through planar contact with each other on the second end surface of the outer conductor.

In some embodiments, the first RF device is configured as a first printed circuit board, and the second RF device is configured as a second printed circuit board.

In some embodiments, the first printed circuit board is configured as a feeder panel, and the second printed circuit board is configured as a calibration plate.

In some embodiments, the first RF device is configured as a power amplifier device, and the second RF device is configured as a filter device.

In some embodiments, the filtering device is configured as a cavity filter.

In some embodiments, the first inner conductor contact portion is electrically connected to the resonator of the cavity filter, and the first outer conductor contact portion is electrically connected to the ground structure of the cavity filter.

In some embodiments, the RF connector is compressed between the first RF device and the second RF device on both end surfaces.

In some embodiments, the RF connector is elastically deformed due to being squeezed on both end surfaces.

In some embodiments, the antenna assembly further comprises an outer cover configured to fasten the antenna assembly and provide an electromagnetic shielding effect.

In some embodiments, the inner conductor and the outer conductor of the RF connector are configured to be in planar contact with the first RF device and the second RF device.

A third aspect of the present disclosure relates to a base station antenna, wherein the base station antenna includes an antenna assembly according to any of embodiments.

Other features and advantages of the subject technology of the present disclosure will be explained in the description below, and in part will be apparent from the description, or may be learned by practice of the subject technology of the present disclosure. The advantages of the subject technology of the present disclosure will be realized and attained by the structure particularly pointed out in the written Specification and Claims hereof as well as the attached drawings.

It should be understood that both the above-mentioned general description and the following detailed description are exemplary and explanatory and are intended to provide further explanation of the subject technology of the present disclosure as claimed.

### BRIEF DESCRIPTION OF THE DRAWINGS

A plurality of aspects of the present disclosure will be better understood after reading the following specific embodiments with reference to the attached drawings. Among the attached drawings:

FIG. 1 schematically shows a perspective view of an antenna assembly according to a first embodiment of the present disclosure;

FIG. 2 shows a schematic exploded view of the antenna assembly of FIG. 1;

FIG. 3 shows a schematic diagram of an antenna assembly according to a second embodiment of the present disclosure;

FIG. 4 schematically shows a perspective view of an RF connector according to the first embodiment of the present disclosure;

FIG. 5a shows a front view of the RF connector of FIG. 4;

FIG. 5b shows a top view of the RF connector of FIG. 4;

FIG. 5c shows a side section view of the RF connector of FIG. 4;

FIG. 6 schematically shows a perspective view of an RF connector according to the second embodiment of the present disclosure;

FIG. 7a shows a front view of the RF connector of FIG. 6;

FIG. 7b shows a top view of the RF connector of FIG. 6;

FIG. 7c shows a side section view of the RF connector of FIG. 6.

### EMBODIMENTS OF THE INVENTION

The present disclosure will be described below with reference to the attached drawings, wherein the attached drawings illustrate certain embodiments of the present disclosure. However, it should be understood that the present disclosure may be presented in many different ways and is not limited to the embodiments described below; in fact, the embodiments described below are intended to make the disclosure of the present disclosure more complete and to fully explain the protection scope of the present disclosure to those of ordinary skill in the art. It should also be understood that the embodiments disclosed in the present disclosure may be combined in various ways so as to provide more additional embodiments.

It should be understood that in all the attached drawings, the same symbols denote the same elements. In the attached drawings, the dimensions of certain features can be changed for clarity.

It should be understood that the words in the Specification are only used to describe specific embodiments and are not intended to limit the present disclosure. Unless otherwise defined, all terms (including technical terms and scientific terms) used in the Specification have the meanings commonly understood by those of ordinary skill in the art. For brevity and/or clarity, well-known functions or structures may not be further described in detail.

The singular forms “a”, “an”, “the” and “this” used in the Specification all include plural forms unless clearly indicated. The words “include”, “contain” and “have” used in the Specification indicate the presence of the claimed features, but do not exclude the presence of one or a plurality of other features. The word “and/or” used in the Specification includes any or all combinations of one or a plurality of the related listed items. The words “between X and Y” and “between approximate X and Y” used in the Specification shall be interpreted as including X and Y. As used herein, the wording “between about X and Y” means “between “approximate X and approximate Y”, and as used herein, the wording “from X to Y” means “from approximate X to approximate Y”.

In the Specification, when an element is referred to as being “on”, “attached” to, “connected” to, “coupled” with, “contacting”, etc., another element, it can be directly on, attached to, connected to, coupled with, or contacting another element or an intermediate element may also be present. In contrast, if an element is described “directly” “on” another element, “directly attached” to another element, “directly connected” to another element, “directly coupled” to another element or “directly contacting” another element, there will be no intermediate elements. In the Specification, a feature that is arranged “adjacent” to another feature, may denote that a feature has a part that overlaps an adjacent feature or a part located above or below the adjacent feature.

In the Specification, words expressing spatial relations such as “upper”, “lower”, “left”, “right”, “front”, “rear”, “top”, and “bottom” may describe the relation between one feature and another feature in the attached drawings. It should be understood that, in addition to the locations shown in the attached drawings, the words expressing spatial relations further include different locations of a device in use or operation. For example, when a device in the attached drawings is turned upside down, the features originally described as being “below” other features now can be described as being “above” the other features”. The device may also be oriented by other means (rotated by 90 degrees or at other locations), and at this time, a relative spatial relation will be explained accordingly.

The present disclosure relates to an antenna assembly for base station antennas, which comprises a first RF device, a second RF device, and an RF connector electrically connecting the first RF device and the second RF device. The RF connector is capable of enabling the transmission of RF signals from the first RF device to the second RF device without the need for additional cables and/or connectors.

In the present disclosure, the RF connector may be manufactured by a co-extrusion molding process, so that the inner conductor, the outer conductor, and the insulator of the RF connector may be formed into an integrated structure, realizing a simple structure of the RF connector. In addition, in the present disclosure, the RF connector may be manufactured through a co-extrusion molding process using flexible materials, such as a polymer, thereby forming a flexible RF connector. In the co-extrusion molding process, the inner conductor and/or outer conductor of the RF connector may be formed by doping a polymer with conductive particles to form a conductive polymer.

It should be understood that the antenna assembly according to the various embodiments of the present disclosure may relate to an assembly composed of any two RF devices, with RF signals transmitted between these two RF devices. In some embodiments, the first RF device may be configured as a first printed circuit board, and the second RF device may be configured as a second printed circuit board. In some embodiments, the first printed circuit board may be configured as a feeder panel, and the second printed circuit board may be configured as a calibration plate. In some embodiments, the first printed circuit board may be configured as a first feeder panel, and the second printed circuit board may be configured as a second feeder panel. In some embodiments, the first printed circuit board may be configured as a first calibration plate, and the second printed circuit board may be configured as a second calibration plate. In other embodiments, the two RF devices may relate to any other RF devices that require transmission of RF signals to each other, such as feeder panels, phase shifters, filters, duplexers, and so on. For example, in some embodiments, the first RF device is configured as a power amplifier device, and the second RF device is configured as a filtering device, such as a cavity filter.

Next, the antenna assembly and the RF connector used for the antenna assembly according to some embodiments of the present disclosure are described in detail with reference to the following attached drawings.

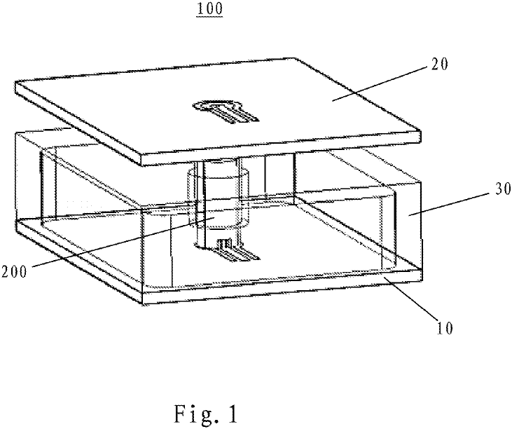

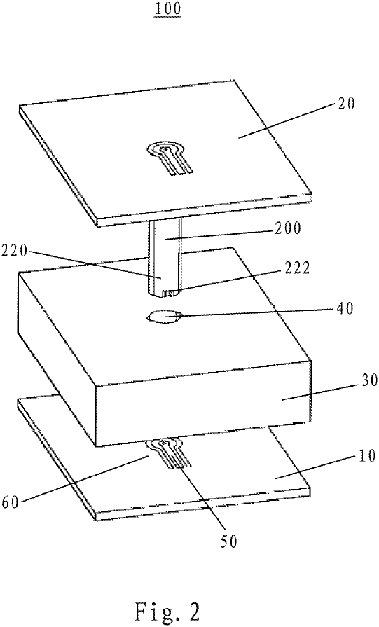

Referring to FIGS. 1 and 2, FIG. 1 schematically shows a perspective view of an antenna assembly according to a first embodiment of the present disclosure; and FIG. 2 shows a schematic exploded view of the antenna assembly of FIG. 1.

In the antenna assembly 100 according to the first embodiment of the present disclosure, the first RF device 10 of the antenna assembly 100 is configured as a first printed circuit board, and the second RF device 20 of the antenna assembly 100 is configured as a second printed circuit board. In addition, the antenna assembly 100 may include a substrate 30 between the first printed circuit board and the second printed circuit board. That is, the first printed circuit board is supported on a first surface of the substrate 30 and the second printed circuit board is supported on a second surface of the substrate 30. The substrate 30 may be configured as a bearing plate of any form, such as a dielectric plate or a metal plate. In some embodiments, the substrate 30 may also be a reflector for the base station antenna.

In addition, the antenna assembly 100 may further include an outer cover configured to fasten the antenna assembly 100, which facilitates the reliable positioning of a flexible RF connector 200 in the antenna assembly 100. The outer cover is also capable of providing electromagnetic shielding for the antenna assembly.

To accommodate the RF connector 200, an opening 40 or a channel for the RF connector 200 may be provided in the substrate 30. The RF connector 200 may cross the substrate 30 through the opening 40 to reach the first printed circuit board and the second printed circuit board at two ends, respectively, and be electrically connected, for example, through planar contact, with the inner conductor contact portion 50 and the outer conductor contact portion 60 printed on the corresponding printed circuit boards, respectively at the two ends. In some embodiments of the present disclosure, the inner conductor and outer conductor of the RF connector 200 may be configured to contact the inner conductor contact portion 50 and the outer conductor contact portion 60 on the first printed circuit board and the second printed circuit board in a planar manner, to enable the transmission of RF signals from the first printed circuit board to the second printed circuit board.

In the current embodiment, the above-mentioned first outer conductor contact portion 60 and the first inner conductor contact portion 50 may be printed on a first surface (for example, the upper surface) of a first printed circuit board (for example, the lower printed circuit board). The shape or contour of the first outer conductor contact portion 60 may at least partially correspond to the contour of the outer conductor of the RF connector 200, so that the first outer conductor contact portion 60 may at least partially contact the outer conductor of the RF connector 200 in a planar manner for conduction. The shape or contour of the first inner conductor contact portion 50 may at least partially correspond to the contour of the inner conductor of the RF connector 200, so that the first inner conductor contact portion 50 may at least partially contact the inner conductor of the RF connector 200 in a planar manner for conduction. In other words, the first inner conductor contact portion 50 and the inner conductor of the RF connector 200 may be electrically connected through planar contact with each other on the first end surface of the inner conductor, and the first outer conductor contact portion 60 and the outer conductor of the RF connector 200 may be electrically connected through planar contact with each other on the first end surface of the outer conductor.

To avoid undesired electrical connection between the inner conductor and the outer conductor during planar contact, a first notch 222 for the inner conductor contact portion 50 may be provided at the end of the outer conductor 220 of the RF connector 200. In addition, the insulator of the RF connector 200 may be formed into a ring shape with at least one second notch in cross-section, so as to remove the conductive polymer of the corresponding outer conductor 220, thereby exposing the insulator.

The inner conductor contact portion 50 may be electrically connected to the conductive portion of the transmission trace (not shown here) on a second surface (here, the lower surface) via a conductor, such as a via hole, a probe, etc., thereby realizing electrical connection between the inner conductor of the RF connector 200 and the RF transmission trace on the printed circuit board. An RF transmission trace for transmitting RF signals may be connected to the conductive portion of the transmission trace. The outer conductor contact portion 60 may be electrically connected to the ground portion on the first surface via a conductor, such as a via hole, a probe, etc., so as to realize an electrical connection between the outer conductor 220 of the RF connector 200 and the ground layer on the printed circuit board.

Similarly, the second outer conductor contact portion 60 and the second inner conductor contact portion 50 mentioned above may be printed on a second surface (for example, the lower surface) of a second printed circuit board (for example, the upper printed circuit board). The second inner conductor contact portion 50 and the inner conductor of the RF connector 200 may be electrically connected through planar contact with each other on the second end surface of the inner conductor, and the second outer conductor contact portion 60 and the outer conductor 220 of the RF connector 200 may be electrically connected through planar contact with each other on the second end surface of the outer conductor 220.

The second inner conductor contact portion 50 may be electrically connected to the conductive portion of the transmission trace (not shown here) on the second surface (here, the lower surface) via a conductor, such as a via hole, a probe, etc., thereby realizing electrical connection between the inner conductor of the RF connector 200 and the RF transmission trace on the printed circuit board. An RF transmission trace for transmitting RF signals may be connected to the conductive portion of the transmission trace. The second outer conductor contact portion 60 may be electrically connected to the ground portion on the first surface via a conductor, such as a via hole, a probe, etc., so as to realize an electrical connection between the outer conductor 220 of the RF connector 200 and the ground layer on the printed circuit board.

As shown in FIGS. 1 and 2, the inner conductor contact portion 50 may have a circular section and a linear section. The outer conductor contact portion 60 may have a circular arc section and linear sections on both sides, and the outer conductor contact portion 60 may at least partially surround the inner conductor contact portion 50. For example, the arc section of the outer conductor contact portion 60 may surround the circular section of the inner conductor contact portion 50, and the linear sections on both sides of the outer conductor contact portion 60 may surround the linear section of the inner conductor contact portion 50 on both sides, thereby realizing a smooth transition of RF signals from the RF connector 200 to the RF devices. In addition, as shown in the figures, the outer conductor contact portion 60 may have substantially the same design form as the ground portion on the back side, and the inner conductor contact portion 50 may have substantially the same design form as the conductive portion of the transmission trace on the back side. Of course, in other embodiments, the outer conductor contact portion 60, the ground portion, the inner conductor contact portion 50, and the transmission trace conductive portion may each have a design form that deviates from the above-mentioned design form. This should not be restrictively interpreted herein.

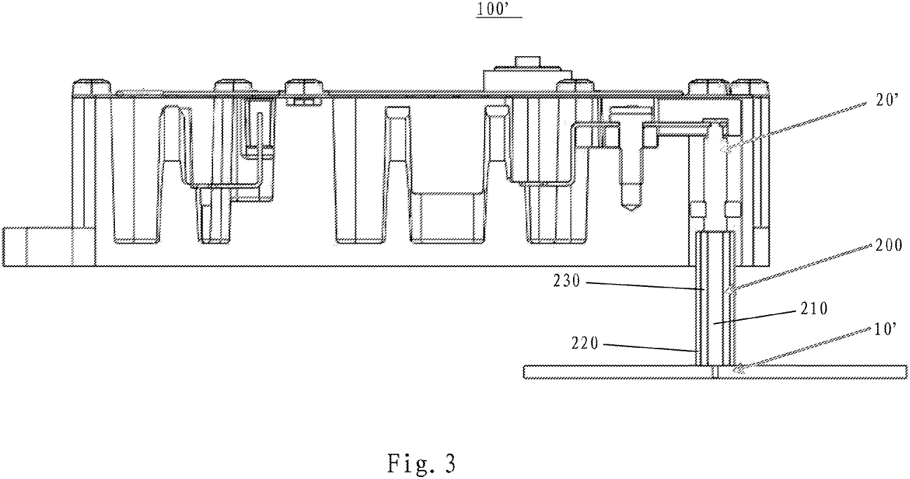

FIG. 3 shows a schematic diagram of an antenna assembly 100ʹ according to a second embodiment of the present disclosure. In the antenna assembly 100ʹ according to the second embodiment of the present disclosure, the first RF device 10ʹ of the antenna assembly 100ʹ may be configured as a first printed circuit board, such as a power amplifier board, and the second RF device 20ʹ of the antenna assembly 100ʹ may be configured as a cavity filter. For the sake of clarity, the substrate between the first printed circuit board and the second printed circuit board is omitted in FIG. 3. The RF connector 200 may cross the substrate through the opening or channel on the substrate to reach the power amplifier board and the cavity filter at both ends, respectively, and be electrically connected, for example, through planar contact, with the inner conductor contact portion 50 and the outer conductor contact portion 60 provided at both ends, respectively (please refer to the corresponding design forms in FIG. 1 and FIG. 2).

In the current embodiment, a first outer conductor contact portion and a first inner conductor contact portion are provided in the cavity filter, and the shape or contour of the first outer conductor contact portion may at least partially correspond to the contour of the outer conductor 220 of the RF connector 200, so that the first outer conductor contact portion may at least partially contact the outer conductor 220 of the RF connector 200 in a planar manner for conduction. The shape or contour of the first inner conductor contact portion may at least partially correspond to the contour of the inner conductor 210 of the RF connector 200, so that the first inner conductor contact portion may at least partially contact the inner conductor 210 of the RF connector 200 in a planar manner for conduction. In other words, the first inner conductor contact portion and the inner conductor 210 of the RF connector 200 may be electrically connected through planar contact with each other on the first end surface of the inner conductor 210, and the first outer conductor contact portion and the outer conductor 220 of the RF connector 200 may be electrically connected through planar contact with each other on the first end surface of the outer conductor 220. In addition, the first inner conductor contact portion may be electrically connected to the resonator of the cavity filter, and the first outer conductor contact portion may be electrically connected to the ground structure of the cavity filter, such as the housing, so as to enable the effective transmission of RF signals to the cavity filter. In some embodiments of the present disclosure, the inner conductor 210 and the outer conductor 220 of the RF connector 200 may be configured to contact the inner conductor contact portion and the outer conductor contact portion of the power amplifier board and the cavity filter in a planar manner, so as to enable the transmission of RF signals from the power amplifier board to the cavity filter.

For the mode of connection between the RF connector and the power amplifier board, please refer to the content of the antenna assembly according to the first embodiment of the present disclosure, which will not be repeated here.

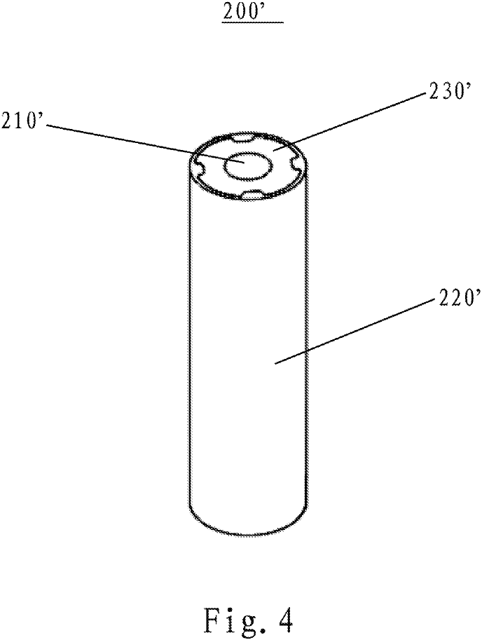

Next, with reference to FIG. 4 to 7c, different design solutions of the RF connector 200 according to some embodiments of the present disclosure are specifically introduced.

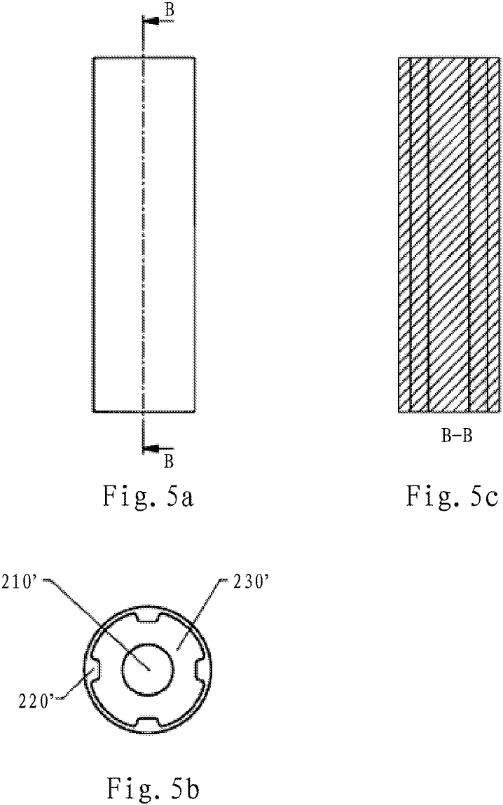

FIG. 4 shows an RF connector 200ʹ according to the first embodiment of the present disclosure, wherein FIG. 5a shows a front view of the RF connector 200ʹ of FIG. 4; FIG. 5b shows a top view of the RF connector 200ʹ of FIG. 4; and FIG. 5c shows a side section view of the RF connector 200ʹ of FIG. 4.

In the RF connector 200ʹ according to the first embodiment of the present disclosure, the RF connector 200ʹ may be configured as a cylindrical connector. To this end, the cross-sectional shape of the opening 40 on the substrate 30 may be correspondingly designed to be substantially circular. It should be understood that the RF connector 200ʹ may be configured as a connector of any other shape, such as prismatic shape, pyramid shape, etc.

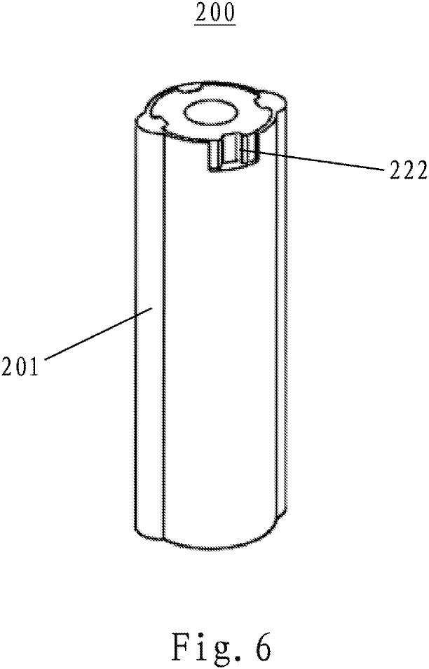

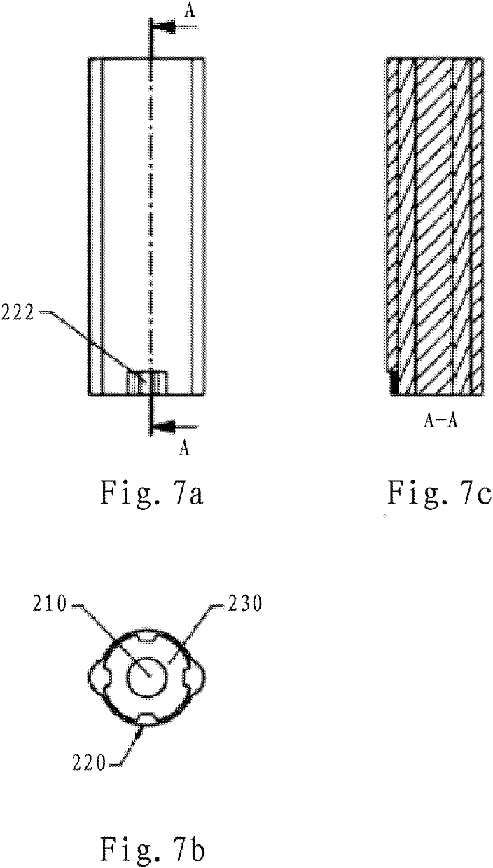

FIG. 6 shows an RF connector 200 according to the second embodiment of the present disclosure, wherein FIG. 7a shows a front view of the RF connector 200 of FIG. 6; FIG. 7b shows a top view of the RF connector 200 of FIG. 6; and FIG. 7c shows a side section view of the RF connector 200 of FIG. 6.

In the RF connector 200 according to the second embodiment of the present disclosure, protruding bar(s) 201, for example, two opposite protruding bars, may be formed on the outer surface of the RF connector 200. The protruding bar may extend from the first end surface of the RF connector 200 to the opposite second end surface along the longitudinal direction of the RF connector 200. To this end, the cross-sectional shape of the opening 40 on the substrate 30 may be correspondingly designed to be substantially oval or olive-shaped. The protruding bars may be inserted into the narrow parts on both sides of the oval or olive-shaped opening 40 so as to lock the RF connector 200 for positioning.

The inner conductor 210, 210ʹ of the RF connector 200, 200ʹ may be configured as a conductive column or conductive pin in the central area of the RF connector 200, 200ʹ, which extends from the first end surface to the opposite second end surface of the RF connector 200, 200ʹ. The insulator 230, 230ʹ of the RF connector 200, 200ʹ may surround the inner conductor 210, 210ʹ, so that the inner conductor 210, 210ʹ of the RF connector 200, 200ʹ and the outer conductor 220, 220ʹ of the RF connector 200, 200ʹ are insulated from each other. The outer conductor 220 of the RF connector 200, 200ʹ may be configured as a conductor part on the outer periphery of the RF connector, which also extends from the first end surface to the opposite second end surface of the RF connector.

In the present disclosure, the inner conductor of the RF connector 200, 200ʹ may be configured as a conductive column or conductive pin in the central area of the RF connector, which extends from the first end surface to the opposite second end surface of the RF connector. The insulator of the RF connector may surround the inner conductor, so that the inner conductor of the RF connector and the outer conductor of the RF connector are insulated from each other. The outer conductor of the RF connector may be configured as a conductor part on the outer periphery of the RF connector, which also extends from the first end surface to the opposite second end surface of the RF connector. According to some embodiments of the present disclosure, in order to enable planar contact between the inner conductor contact portion and the outer conductor contact portion of the corresponding RF devices, the inner conductor and outer conductor of the RF connector 200, 200ʹ may be configured flush with each other on the first end surface and the second end surface.

The RF connector 200, 200ʹ according to the present disclosure may be manufactured by a co-extrusion molding process, wherein the RF connector 200, 200ʹ may be formed into a body of the RF connector by a polymer, such as silicone rubber. In addition, in order to form the conductivity of the inner conductor and the outer conductor, conductive particles, such as aluminum particles, silver particles, and/or copper particles, may be doped into the polymer body of the inner conductor and the outer conductor.

In view of the polymer-based body, the RF connector 200, 200ʹ may be configured as a flexible RF connector. Thus, the RF connector can be compressed between the first RF device and the second RF device on both end surfaces, so that the inner conductor and the outer conductor doped with conductive particles are in planar contact with the inner conductor contact portion and the outer conductor contact portion provided on the first RF device and the second RF device.

Although the exemplary embodiments of the present disclosure have been described, it should be understood by those of ordinary skill in the art that a plurality of variations and changes can be created and made to the exemplary embodiments of the present disclosure without essentially departing from the spirit and scope of the present disclosure. Therefore, all variations and changes are included in the protection scope of the present disclosure defined by the claims. The present disclosure is defined by the attached claims, and equivalents of these claims are also included.

1. An RF connector for base station antennas, which comprises an inner conductor, an outer conductor, and an insulator between the inner conductor and the outer conductor, wherein the inner conductor and the outer conductor of the RF connector are formed of conductive polymer, and the RF connector is manufactured through a co-extrusion molding process.

2. The RF connector according to claim 1, wherein the RF connector is configured as a flexible RF connector.

3. The RF connector according to claim 1, wherein the inner conductor, the outer conductor, and the insulator of the RF connector are constructed in one piece by means of the co-extrusion molding process.

4. The RF connector according to claim 1, wherein
the inner conductor of the RF connector includes an inner conductor body composed of an insulating polymer and conductive particles doped into the inner conductor body;
the insulator of the RF connector is composed of the insulating polymer; and
the outer conductor of the RF connector includes an outer conductor body composed of the insulating polymer and conductive particles doped into the outer conductor body.

5. (canceled)

6. The RF connector according to claim 4, wherein the conductive particles are aluminum particles, silver particles, and/or copper particles.

7. The RF connector according to claim 1, wherein the RF connector is configured as a cylindrical connector.

8. The RF connector according to claim 1, wherein the inner conductor of the RF connector is configured as a conductive column in the central area of the RF connector.

9. The RF connector according to claim 1, wherein a first notch is provided at the end of the outer conductor of the RF connector so as to remove the corresponding conductive polymer, thereby exposing the insulator.

10. (canceled)

11. The RF connector according to claim 1, wherein the outer conductor of the RF connector is formed with at least one protruding bar on the outer surface.

12. (canceled)

13. The RF connector according to claim 1, wherein the RF connector is configured to electrically connect the first RF device and the second RF device in a base station antenna.

14. The RF connector according to claim 13, wherein
the inner conductor of the RF connector is electrically connected to the transmission trace on the first RF device at the first end surface, and the outer conductor of the RF connector is electrically connected to the ground portion on the first RF device at the first end surface; and
the inner conductor of the RF connector is electrically connected to the transmission trace on the second RF device at the second end surface, and the outer conductor of the RF connector is electrically connected to the ground portion on the second RF device at the second end surface.

15. (canceled)

16. An antenna assembly comprising a first RF device, a second RF device, and an RF connector electrically connecting the first RF device and the second RF device, wherein the RF connector is configured as an RF connector according to claim 1.

17. The antenna assembly according to claim 16, wherein the antenna assembly further comprises a substrate between the first RF device and the second RF device, wherein an opening for the RF connector to span is provided in the substrate.

18. (canceled)

19. The antenna assembly according to claim 16, wherein
a first inner conductor contact portion and a first outer conductor contact portion are provided on the first RF device, wherein the first inner conductor contact portion and the inner conductor of the RF connector are electrically connected through planar contact with each other on the first end surface of the inner conductor, and the first outer conductor contact portion and the outer conductor of the RF connector are electrically connected through planar contact with each other on the first end surface of the outer conductor; and
a second inner conductor contact portion and a second outer conductor contact portion are provided on the second RF device, wherein the second inner conductor contact portion and the inner conductor of the RF connector are electrically connected through planar contact with each other on the second end surface of the inner conductor, and the second outer conductor contact portion and the outer conductor of the RF connector are electrically connected through planar contact with each other on the second end surface of the outer conductor.

20. The antenna assembly according to claim 16, wherein the first RF device is configured as a first printed circuit board, and the second RF device is configured as a second printed circuit board.

21-24. (canceled)

25. The antenna assembly according to claim 16, wherein the RF connector is compressed between the first RF device and the second RF device on both end surfaces.

26. The antenna assembly according to claim 25, wherein the RF connector is elastically deformed due to being squeezed on both end surfaces.

27. The antenna assembly according to claim 16, wherein the antenna assembly further comprises an outer cover configured to fasten the antenna assembly and provide an electromagnetic shielding effect.

28. The RF connector according to claim 16, wherein the inner conductor and the outer conductor of the RF connector are configured to be in planar contact with the first RF device and the second RF device.

29. A base station antenna, wherein the base station antenna includes an antenna assembly according to claim 16.
